(19) United States
(12) Patent Application Publication
(10) Pub. No.: US 2026/0349294 A1
(43) Pub. Date: Nov. 5, 2026

(54) DISPLAY APPARATUS

(71) Applicant: SAMSUNG ELECTRONICS CO., LTD., Suwon-si (KR)

(72) Inventors: Jin PARK, Suwon-si (KR); Yongje MOON, Suwon-si (KR); Sehwan IN, Suwon-si (KR); Jaesung LEE, Suwon-si (KR)

(73) Assignee: SAMSUNG ELECTRONICS CO., LTD., Suwon-si (KR)

(21) Appl. No.: 19/709,789

(22) Filed: Jun. 16, 2026

Related U.S. Application Data
(63) Continuation of application No. PCT/KR2026/001492, filed on Jan. 26, 2026.

(30) Foreign Application Priority Data
Mar. 21, 2025 (KR) 10-2025-0036876

(51) Int. Cl. G02F 1/1333

(52) U.S. Cl. CPC G02F 1/133314

(57) ABSTRACT

A display apparatus includes: a display panel; an optical member on a rear side of the display panel; a rear chassis configured to support the display panel and the optical member; and a supporter between the optical member and the rear chassis, where the supporter includes: a plate portion on a front surface of the rear chassis; a base portion including a first end and a second end, the first end being connected to the plate portion and the second end being spaced apart from the plate portion; and a protrusion protruding forwardly from the base portion.

### CROSS-REFERENCE TO RELATED APPLICATION(S)

This application is a continuation of International Application No. PCT/KR2026/001492, filed on Jan. 26, 2026, in the Korean Intellectual Property Receiving Office, which is based on and claims priority to Korean Patent Application No. 10-2025-0036876, filed on Mar. 21, 2025, in the Korean Intellectual Property Office, the disclosures of which are incorporated by reference herein in their entireties.

### BACKGROUND

### 1. Field

The disclosure relates to a display apparatus having an improved structure.

### 2. Description of Related Art

A display apparatus is a type of output device that converts acquired or stored electrical information into visual information and displays such information to a user.

A display apparatus may include a self-emissive display panel, such as an organic light-emitting diode (OLED) or a non-emissive display panel, such as a liquid crystal display (LCD).

A display apparatus including a non-emissive display panel may include a backlight unit for supplying light to the display panel. The backlight unit may include a light source module and an optical member disposed between the display panel and the light source module to change a characteristic of the light supplied from the light source module.

### SUMMARY

Provided is a display apparatus including a supporter configured to support an optical member and absorb impact caused by an external force to prevent damage to the display apparatus.

Further, provided is a display apparatus with a more improved shock absorption functionality using a dual damping structure of a supporter.

Further still, provided is a display apparatus that facilitates automation of the manufacturing process.

Additional aspects will be set forth in part in the description which follows and, in part, will be apparent from the description, or may be learned by practice of the presented embodiments.

According to an embodiment of the disclosure, a display apparatus may include: a display panel; an optical member on a rear side of the display panel; a rear chassis configured to support the display panel and the optical member; and a supporter between the optical member and the rear chassis, where the supporter includes: a plate portion on a front surface of the rear chassis; a base portion including a first end and a second end, the first end being connected to the plate portion and the second end being spaced apart from the plate portion; and a protrusion protruding forwardly from the base portion.

The base portion may include: an extension portion extending from the plate portion; and a bent portion bent from the extension portion and extending in a direction different than a direction in which the extension portion extends, where the first end of the base portion is at an end of the extension portion that is connected to the plate portion, and the second end of the base portion is at an end of the bent portion along the direction in which the bent portion extends.

The extension portion may extend from an end portion of the plate portion.

The protrusion may be on the bent portion.

The bent portion may be parallel to the plate portion.

The extension portion, the bent portion, and a portion of the plate portion may form a gap therebetween.

The extension portion may extend at an incline with respect to the plate portion, where an angle at which the extension portion is inclined with respect to the portion of the plate portion is 90 degrees or less.

The extension portion may extend at an incline with respect to the bent portion, where an angle at which the extension portion is inclined with respect to the bent portion is 90 degrees or more and 180 degrees or less.

The bent portion may overlap at least a portion of the plate portion with respect to a front-to-back direction.

The display apparatus may further include an adhesive configured to bond the supporter to the front surface of the rear chassis.

The extension portion may further include a first extension portion and a second extension portion that are spaced apart from each other, where the bent portion further includes: a first bent portion bent from the first extension portion; a second bent portion bent from the second extension portion; and a connection portion connecting the first bent portion and the second bent portion and configured to support the protrusion.

The protrusion may be on an inner side of the first bent portion, the second bent portion, and the connection portion.

The protrusion may be spaced apart from the first bent portion and the second bent portion.

The extension portion may further include: a first extension portion extending at an incline with respect to the bent portion; and a second extension portion connecting the first extension portion and the plate portion, where a first angle at which the first extension portion is inclined with respect to the bent portion and a second angle at which the second extension portion is inclined with respect to the bent portion are each 90 degrees or more and 180 degrees or less.

The protrusion may be spaced apart from one end portion of the bent portion along the direction in which the bent portion extends.

According to an embodiment of the disclosure, provided is a supporter for a display apparatus that includes a display panel, an optical member on a rear side of the display panel, and a rear chassis configured to support the display panel and the optical member, the supporter may include: a plate portion on a front surface of the rear chassis; a base portion including a first end and a second end, the first end being connected to the plate portion and the second end being spaced apart from the plate portion; and a protrusion protruding forwardly from the base portion.

The base portion may include: an extension portion extending from the plate portion; and a bent portion bent from the extension portion and extending in a direction different than a direction in which the extension portion extends, where the first end of the base portion is at an end of the extension portion that is connected to the plate portion, and the second end of the base portion is at an end of the bent portion along the direction in which the bent portion extends.

The extension portion may extend from an end portion of the plate portion, where the protrusion is on the bent portion, where the bent portion is parallel to the plate portion, and where the extension portion, the bent portion, and a portion of the plate portion form a gap therebetween.

The extension portion may extend at an incline with respect to the plate portion, where an angle at which the extension portion is inclined with respect to the portion of the plate portion is 90 degrees or less, and where the bent portion at least partially overlaps with the plate portion in a front-to-back direction.

The extension portion may further include a first extension portion and a second extension portion that are spaced apart from each other, where the bent portion further includes: a first bent portion bent from the first extension portion; a second bent portion bent from the second extension portion; and a connection portion connecting the first bent portion and the second bent portion and configured to support the protrusion, where the protrusion is on an inner side of the first bent portion, the second bent portion, and the connection portion, and where the protrusion is spaced apart from the first bent portion and the second bent portion.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view illustrating a display apparatus according to an embodiment;

FIG. 2 is an exploded view illustrating the display apparatus according to an embodiment;

FIG. 3 is a cross-sectional view taken along line A-A′ shown in FIG. 1 according to an embodiment;

FIG. 4 is an enlarged view of portion B shown in FIG. 3 according to an embodiment;

FIG. 5 is a perspective view illustrating a supporter according to an embodiment;

FIG. 6 is a side view illustrating the supporter according to an embodiment;

FIG. 7 is a view illustrating a state in which the supporter is primarily deformed, according to an embodiment;

FIG. 8 is a view illustrating a state in which the supporter is secondarily deformed, according to an embodiment;

FIG. 9 is a view illustrating a manner in which a supporter is attached to a rear chassis, according to an embodiment;

FIG. 10 is a perspective view illustrating a supporter according to an embodiment;

FIG. 11 is a side view illustrating a supporter according to an embodiment;

FIG. 12 is a view illustrating a state in which a supporter is primarily deformed, according to an embodiment; and

FIG. 13 is a view illustrating a state in which a supporter is secondarily deformed according to an embodiment.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

The term of “and/or” includes a plurality of combinations of relevant items or any one item among a plurality of relevant items.

Terms such as “1st”, “2nd”, “primary”, or “secondary” may be used to distinguish an element from other elements, without limiting the element in other aspects (e.g., importance or order).

It will be understood that when the terms “includes”, “comprises”, “has”, “including”, “comprising”, and/or “having” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

The terms “front”, “rear”, “up”, “down”, “left”, “right”, “upper”, “lower”, and the like used in the following description may be defined with reference to the drawings, and the shape and position of each element are not limited by these terms.

For example, an X direction may be defined as a front-to-back direction. For example, a Y direction may be defined as a lateral direction. For example, a Z direction may be defined as an up-and-down direction. For example, the +X direction may be defined as a front, and the −X direction may be defined as a rear. For example, the +Y direction may be defined as a left, and the −Y direction may be defined as a right. For example, the +Z direction may be defined as an upward direction, and the −Z direction may be defined as an downward direction.

Hereinafter, various embodiments according to the present disclosure will be described in detail with reference to the accompanying drawings.

Furthermore, while the following describes a liquid crystal display (LCD) device, as an example for ease of description, the configurations of the present disclosure are not limited to the LCD devices and may be applied to various types of display apparatuses. For example, the configuration of the present disclosure may also be applied to an organic light-emitting diode (OLED) display apparatuses that do not include a backlight unit. In another example, the configuration of the present disclosure may also be applied to micro LED display apparatuses.

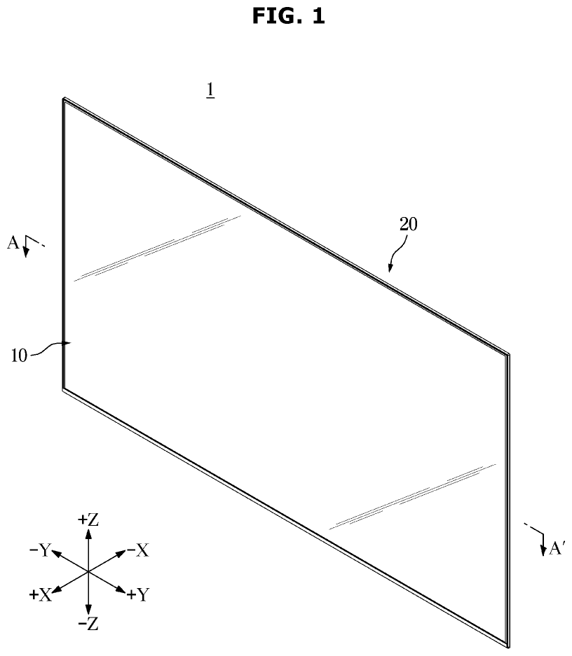

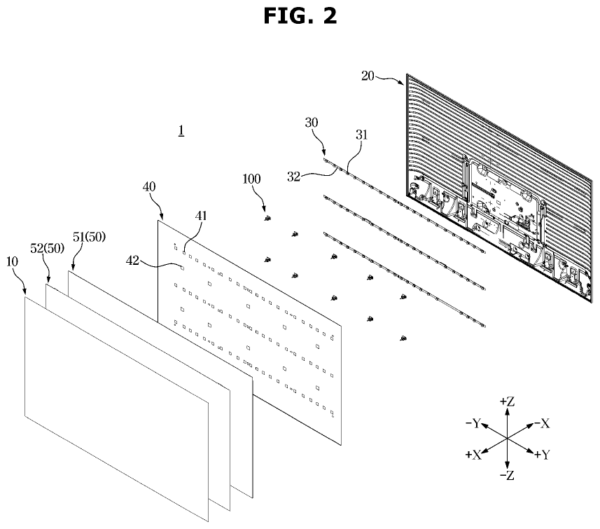

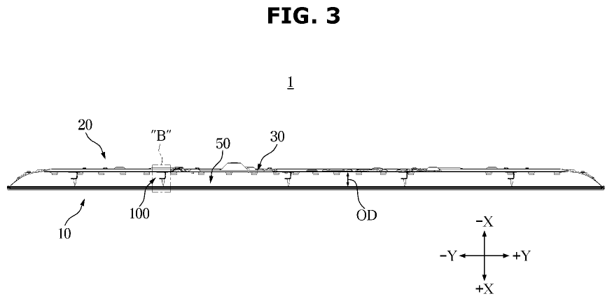

FIG. 1 is a perspective view illustrating a display apparatus according to an embodiment. FIG. 2 is an exploded view illustrating the display apparatus according to an embodiment. FIG. 3 is a cross-sectional view taken along line A-A′ shown in FIG. 1 according to an embodiment.

Referring to FIGS. 1 to 3, a display apparatus 1 may be a device capable of processing an image signal received from an external source and visually displaying the processed image. Hereinafter, a case where the display apparatus 1 is a television (TV) is exemplified, but the present disclosure is not limited thereto. For example, the display apparatus 1 may be implemented in various forms, such as a monitor, a portable multimedia device, a portable communication device, and the like, and its form is not limited as long as it is a device that visually displays images.

In addition, the display apparatus 1 may be a large format display (LFD) installed outdoors, such as on a building rooftop or at a bus stop. Here, outdoors is not necessarily limited to the open air, and the display apparatus 1 according to an embodiment may be installed in places where a large number of people may enter and exit, even if indoors, such as a subway station, a shopping mall, a movie theater, a company, a store, and the like.

The display apparatus 1 may receive content including video signals and audio signals from various content sources, and output video and audio corresponding to the video signals and audio signals. For example, the display apparatus 1 may receive content data via a broadcast receiving antenna or a wired cable, receive content data from a content playback device, or receive content data from a content delivery server of a content provider.

The display apparatus 1 may include a display panel 10. The display panel 10 may be configured to display an image. The display panel 10 shown in FIGS. 1 and 2 has a flat shape, but the display panel 10 may have a curved shape.

The display apparatus 1 may include a backlight unit (BLU). The BLU may be disposed on a rear side of the display panel 10 and may be arranged to provide light to the display panel 10.

The display apparatus 1 may include a rear chassis 20. The rear chassis 20 may be disposed on the rear side of the display panel 10. The rear chassis 20 may cover the rear side of the display panel 10. The rear chassis 20 may be configured to support the display panel 10.

The rear chassis 20 may be configured to support various components of the BLU. For example, the rear chassis 20 may support a reflective sheet 40 and an optical member 50, which will be described later.

The BLU may include a light source module 30. The light source module 30 may be configured to generate light and provide light to the display panel 10. The light source module 30 may be disposed on the rear side of the display panel 10. The light source module 30 may be provided on a front surface of the rear chassis 20.

The light source module 30 may include a light source 31 and a substrate 32 on which the light source 31 is mounted. The light source 31 and the substrate 32 may each be provided in a plurality. For example, a plurality of light sources 31 may be arranged spaced apart from each other on one substrate 32, and a plurality of substrates 32 may be arranged spaced apart from each other on the front surface of the rear chassis 20. However, this is merely one example, and there is no particular limitation on an arrangement method of each of the plurality of light sources 31 and the plurality of substrates 32.

The BLU may include the reflective sheet 40. The reflective sheet 40 may be configured to reflect light emitted from the light source 31. For example, the reflective sheet 40 may reflect light emitted from the light source 31 in a forward direction or a direction approximate to the forward direction.

The reflective sheet 40 may be disposed on a front side of the rear chassis 20. For example, the reflective sheet 40 may be provided on the front surface of the rear chassis 20.

The reflective sheet 40 may include a first through-hole 41. The first through-hole 41 may be formed at a position corresponding to the light source 31. The light source 31 may be configured to pass through the first through-hole 41, and at least a portion of the light source 31 may protrude in front of the reflective sheet 40.

The first through-holes 41 may be provided in a plurality. The number of the first through-holes 41 may correspond to a number of the light sources 31.

The reflective sheet 40 may include a second through-hole 42. The second through-hole 42 may be formed at a position corresponding to a supporter 100, which will be described later. The supporter 100 may be configured to pass through the second through-hole 42, and at least a portion of the supporter 100 may protrude forward of the reflective sheet 40.

The second through-holes 42 may be provided in a plurality. The number of the second through-holes 42 may correspond to the number of supporters 100, which will be described later.

The BLU may include the optical member 50. The optical member 50 may be configured to change the characteristics of light emitted from the light source 31.

The optical member 50 may be disposed on the rear side of the display panel 10. The optical member 50 may be disposed on a front side of the reflective sheet 40. The optical member 50 may be disposed on a front side of the light source module 30.

The optical members 50 may be provided in a plurality. For example, the optical member 50 may include a first optical member 51 and a second optical member 52 provided in front of the first optical member 51. However, this is merely one example, there is no particular limitation on the number of the optical members 50.

For example, the first optical member 51 may include a diffusion plate. The diffusion plate may be configured to uniformly diffuse light emitted from the light source 31. The diffusion plate may diffuse light emitted from the plurality of light sources 31 within the diffusion plate to eliminate unevenness in luminance caused by the plurality of light sources 31. In other words, the diffusion plate may uniformly emit uneven light from the plurality of light sources 31 forward.

For example, the second optical member 52 may include various optical sheets for improving the luminance of the emitted light and the uniformity of luminance. For example, the second optical member 52 may include a diffusion sheet, a prism sheet, a reflective polarizing sheet, a quantum dot sheet, or the like.

This is merely one example, and there is no particular limitations on each of the first optical member 51 and the second optical member 52. Thus, each of the first optical member 51 and the second optical member 52 may include a wider variety of sheets or films.

The optical member 50 may be spaced apart from the front surface of the rear chassis 20 by a predetermined distance. For example, the second optical member 52 may be spaced apart from the front surface of the rear chassis 20 by a predetermined distance. A distance by which the optical member 50 and the rear chassis 20 are spaced apart from each other may be referred to as an optical distance (OD).

The optical member 50 may be spaced apart from the front surface of the rear chassis 20 by the OD. With such a configuration, the optical member 50 may be spaced apart from the light source module 30 that is provided on the front surface of the rear chassis 20. Accordingly, the light source module 30 may maintain its optical characteristics, and light emitted from the light source 31 may be uniformly distributed.

The display apparatus 1 may include the supporter 100. The supporter 100 may be disposed between the optical member 50 and the rear chassis 20. The supporter 100 may be attached to the front surface of the rear chassis 20 and configured to support the optical member 50.

The supporter 100 may be configured to maintain the OD between the optical member 50 and the rear chassis 20. Furthermore, the supporter 100 may absorb impact caused by an external force applied to the display apparatus 1, thereby preventing damage to the display apparatus 1.

The supporter 100 may be provided in a plurality. The plurality of supporters 100 may be spaced apart from each other. However, this is merely one example, and there is no particular limitation on an arrangement method of the plurality of supporters 100.

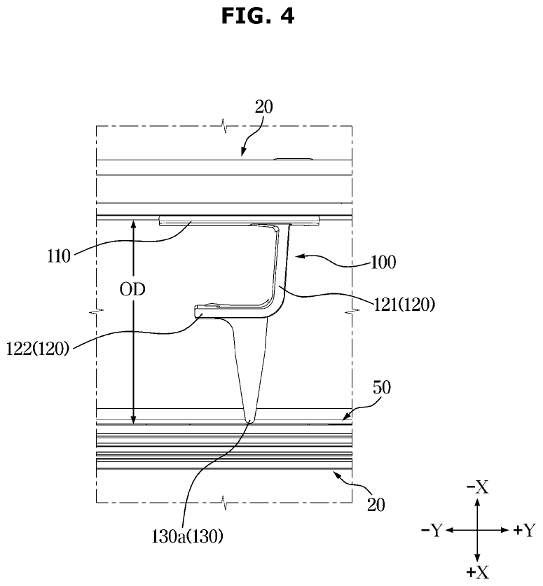

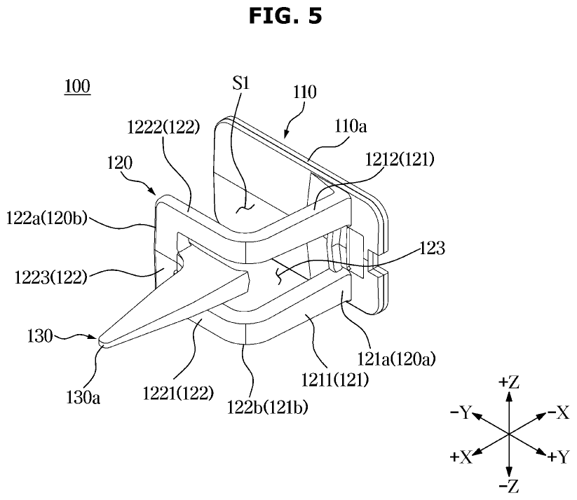

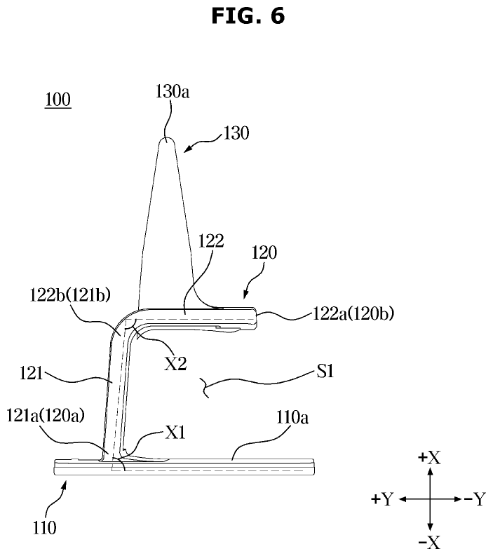

FIG. 4 is an enlarged view of portion B shown in FIG. 3 according to an embodiment. FIG. 5 is a perspective view illustrating a supporter according to an embodiment. FIG. 6 is a side view illustrating the supporter according to an embodiment.

Referring to FIGS. 4 to 6, the supporter 100 may include a plate portion 110. The plate portion 110 may include a front surface and a rear surface that are flush with each other. The plate portion 110 may be provided on the front surface of the rear chassis 20. In other words, the plate portion 110 may be attached to the front surface of the rear chassis 20.

Although the plate portion 110 is shown in the drawings as having a rectangular cross-section, there is no particular limitation on a cross-sectional shape of the plate portion 110. For example, the plate portion 110 may have a circular cross-section.

The plate portion 110 may include at least on rib for reinforcing rigidity.

The supporter 100 may include a base portion 120. The base portion 120 may protrude from the plate portion 110. Stated differently, the base portion 120 may extend from the plate portion 110. A direction in which the base portion 120 protrudes/extends from the plate portion 110 may be approximately a forward direction.

For example, the base portion 120 may protrude from one end of the plate portion 110. Stated differently, the base portion 120 may extend from one end portion of the plate portion 110.

One end portion 120a of the base portion 120 may be connected to the plate portion 110. The other end portion 120b of the base portion 120 may be spaced apart from the plate portion 110. For example, the other end portion 120b of the base portion 120 may be spaced apart from the plate portion 110 in a forward direction.

The base portion 120 may include an extension portion 121. The extension portion 121 may be a portion of the base portion 120 extending from the plate portion 110. In other words, the extension portion 121 may be a portion of the base portion 120 protruding from the plate portion 110. The extension portion 121 may extend at an incline with respect to the plate portion 110.

The one end portion 120a of the base portion 120 connected to the plate portion 110 may be one end portion 121a of the extension portion 121. In other words, the one end portion 121a of the extension portion 121 may be connected to the plate portion 110.

The extension portion 121 may protrude from one end portion of the plate portion 110. Stated differently, the extension portion 121 may extend from one end portion of the plate portion 110.

The base portion 120 may include a bent portion 122. The bent portion 122 may be another portion of the base portion 120 bent from the extension portion 121.

The bent portion 122 may extend in a direction different from a direction in which the extension portion 121 extends. For example, the extension portion 121 may extend at an incline in a front direction (+X direction) from the plate portion 110, and the bent portion 122 may extend in a right direction (−Y direction) from the extension portion 121.

The other end portion 120b of the base portion 120 spaced apart from the plate portion 110 may be one end portion 122a of the bent portion 122 along a direction in which the bent portion 122 extends. In other words, the one end portion 122a of the bent portion 122 along the direction in which the bent portion 122 extends may be spaced apart from the plate portion 110. The one end portion 122a of the bent portion 122 along the direction in which the bent portion 122 extends may be spaced forwardly from the plate portion 110.

The other end portion 122b of the bent portion 122 provided opposite the one end portion 122a of the bent portion 122 may be the other end portion 121b of the extension portion 121. Thus, the other end portion 122b of the bent portion 122 provided on the opposite side of the one end portion 122a of the bent portion 122 may be connected to the plate portion 110 by the extension portion 121.

The bent portion 122 may be provided parallel to the plate portion 110. For example, the plate portion 110 may be provided on a plane (YZ plane) extending in a left-to-right direction (Y-axis direction) and an up-and-down direction (Z-axis direction), and the bent portion 122 may extend in a right direction (−Y direction) from the extension portion 121. However, a direction in which the bent portion 122 extends is not limited thereto.

The extension portion 121 and the bent portion 122 may form a gap S1 together with a portion 110a of the plate portion 110. In other words, the base portion 120 may form the gap S1 together with the portion 110a of the plate portion 110. The gap S1 may separate the bent portion 122 and the portion 110a of the plate portion 110.

As described above, the extension portion 121 may extend at an incline with respect to the plate portion 110. An angle X1 at which the extension portion 121 is inclined with respect to the portion 110 a of the plate portion 110 may be 90 degrees or less. According to an embodiment, the angle X1 at which the extension portion 121 is inclined with respect to the portion 110 a of the plate portion 110 may be less than 90 degrees. For example, the angle X1 between the extension portion 121 and the portion 110a of the plate portion 110 may be an acute angle.

The extension portion 121 may extend at an incline with respect to the bent portion 122. An angle X2 at which the extension portion 121 is inclined with respect to the bent portion 122 may be 90 degrees or more and 180 degrees or less. According to an embodiment, the angle X2 at which the extension portion 121 is inclined with respect to the bent portion 122 may be greater than 90 degrees and less than 180 degrees. For example, the angle X2 between the extension portion 121 and the bent portion 122 may be an obtuse angle.

The bent portion 122 may overlap at least a portion of the plate portion 110 in a front-to-back direction. For example, the bent portion 122 may overlap with the portion 110a of the plate portion 110 in the front-to-back direction.

The supporter 100 may include a protrusion 130. The protrusion 130 may protrude forwardly from the base portion 120. Stated differently, the protrusion 130 may protrude from the base portion 120 toward the optical member 50.

The protrusion 130 may be provided on the bent portion 122. In other words, the protrusion 130 may protrude forwardly from the bent portion 122. Stated differently, the protrusion 130 may protrude from the bent portion 122 toward the optical member 50.

One end portion 130a of the protrusion 130 may be in contact with the optical member 50. For example, the one end portion 130a of the protrusion 130 along a direction in which the protrusion 130 protrudes may be in contact with the optical member 50. With such a configuration, the supporter 100 may support the optical member 50 to maintain the optical distance OD between the optical member 50 and the rear chassis 20.

The protrusion 130 may have a shape such that the thickness thereof decreases in a direction in which the protrusion 130 protrudes. Stated differently, the one end portion 130a of the protrusion 130 along the direction in which the protrusion 130 protrudes may have a narrower thickness than the other end portion 130b of the protrusion 130 provided opposite the one end portion 130a of the protrusion 130. In other words, the one end portion 130a of the protrusion 130 in contact with the optical member 50 may have a relatively narrow thickness. With such a configuration, it is possible to prevent the supporter 100 from being visible on a screen of the display panel 10.

According to an embodiment, the supporter 100 may be integrally formed. For example, the plate portion 110, the base portion 120, and the protrusion 130 may be integrally formed with each other. The supporter 100 may include a plastic material. For example, the supporter 100 may include at least one of polycarbonate (PC), polyphenylene ether (PPE), Nylon, polyphenylene sulfide (PPS), polyphthalamide (PPA), acrylonitrile butadiene styrene copolymer (ABS), poly (cyclohexylene dimethylene terephthalate) glycol (PCTG), and polyethylene terephthalate glycol (PETG). However, the material of the supporter 100 is not limited thereto.

The supporter 100 may be elastically deformable. Through such a configuration, the supporter 100 may absorb impact applied to the supporter 100. More details on this will be described later.

In the following, a structure of the supporter 100 according to an embodiment will be discussed in more detail.

Referring to FIGS. 5 and 6, the extension portion 121 may include a first extension portion 1211 and a second extension portion 1212. The first extension portion 1211 and the second extension portion 1212 may be spaced apart from each other. For example, the first extension portion 1211 and the second extension portion 1212 may be spaced apart in the up-and-down direction (Z-axis direction). Thus, a space between the first extension portion 1211 and the second extension portion 1212 may be open.

The bent portion 122 may include a first bent portion 1221 and a second bent portion 1222. The first bent portion 1221 may be bent from the first extension portion 1211. The second bent portion 1222 may be bent from the second extension portion 1212.

The first bent portion 1221 and the second bent portion 1222 may be spaced apart from each other. For example, the first bent portion 1221 and the second bent portion 1222 may be spaced apart in the up-and-down direction (Z-axis direction).

The bent portion 122 may include a connection portion 1223 connecting the first bent portion 1221 and the second bent portion 1222. For example, the connection portion 1223 may extend in the up-and-down direction (Z-axis direction).

The connection portion 1223 may be provided to support the protrusion 130. For example, the protrusion 130 may be supported by the connection portion 1223 by being connected to the connection portion 1223.

The protrusion 130 may be provided on an inner side of the first bent portion 1221, the second bent portion 1222, and the connection portion 1223. In other words, the protrusion 130 may be positioned, based on the connection portion 1223, in a direction opposite to a direction in which the bent portion 122 extends from the extension portion 121. For example, the bent portion 122 may extend in the right direction (−Y direction) from the extension portion 121, and the protrusion 130 may be positioned in the left direction (+Y direction) based on the connection portion 1223.

The protrusion 130 may be spaced apart from the first bent portion 1221. For example, the protrusion 130 and the first bent portion 1221 may be spaced apart in the up-and-down direction (Z-axis direction). Thus, a space between the protrusion 130 and the first bent portion 1221 may be open.

The protrusion 130 may be spaced apart from the second bent portion 1222. For example, the protrusion 130 and the second bent portion 1222 may be spaced apart in the up-and-down direction (Z-axis direction). Thus, a space between the protrusion 130 and the second bent portion 1222 may be open.

As described above, the space between the first extension portion 1211 and the second extension portion 1212, the space between the protrusion 130 and the first bent portion 1221, and the space between the protrusion 130 and the second bent portion 1222 may be open. In other words, the base portion 120 may include an opening 123 formed by the first extension portion 1211, the second extension portion 1212, the first bent portion 1221, the second bent portion 1222, the connection portion 1223, and the protrusion 130.

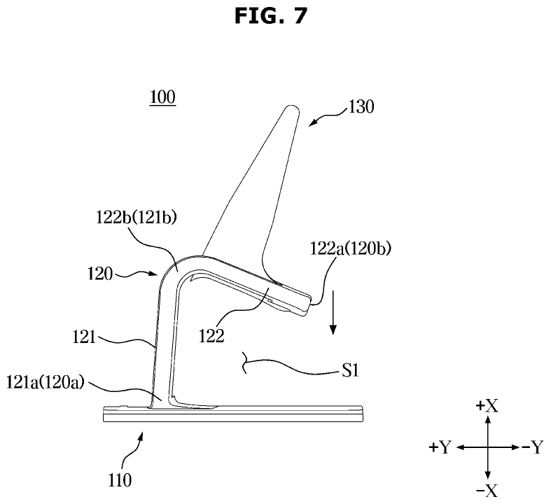

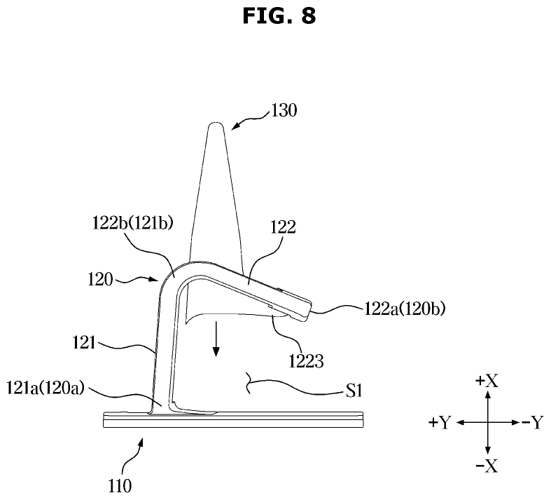

FIG. 7 is a view illustrating a state in which the supporter is primarily deformed according to an embodiment. FIG. 8 is a view illustrating a state in which the supporter is secondarily deformed according to an embodiment.

Referring to FIGS. 6 to 8, in a situation where an external force is applied to the display apparatus 1, the supporter 100 may be compressed. For example, since the supporter 100 is a configuration disposed between the optical member 50 and the rear chassis 20 arranged in the front-to-back direction (X-axis direction), the supporter 100 may be compressed in the front-to-back direction (X-axis direction). During such a process, the supporter 100 may undergo elastic deformation and absorb impact applied to the supporter 100.

The supporter 100 may have a dual damping structure to absorb the impact applied to the supporter 100. That is, the supporter 100 may absorb the impact by elastically deforming along two bending points.

In the following, a process by which the supporter 100 undergoes elastic deformation when the supporter 100 is compressed in the front-to-back direction (X-axis direction) will be discussed.

First, the supporter 100 may be bent with a connection portion between the extension portion 121 and the bent portion 122 as one bending point. Stated differently, the supporter 100 may be bent with the other end portion 121b of the extension portion 121, or the other end portion 122b of the bent portion 122, as one bending point. This is due to the structure of the base portion 120, wherein the one end portion 122a of the bent portion 122 is spaced apart from the plate portion 110, and the other end portion 122b of the bent portion 122 is connected to the plate portion 110 by the extension portion 121. Through the elastic deformation process described above, the supporter 100 may firstly absorb impact.

As the supporter 100 is bent along the bending point described above, the one end portion 122a of the bent portion 122 may be moved rearwardly. Stated differently, as the supporter 100 is bent along the above bending point, the one end portion 122a of the bent portion 122 may move inwardly into the gap S1.

Thereafter, the supporter 100 may be bent with the connection portion 1223 of the bent portion 122 as the other bending point. Through the elastic deformation process described above, the supporter 100 may secondarily absorb impact.

As the supporter 100 is bent along the aforementioned bending points, the protrusion 130 may be moved rearwardly. Stated differently, as the supporter 100 is bent along the aforementioned bending points, the protrusion 130 may move inwardly into the gap S1.

As described above, the supporter 100 may have a dual damping structure to absorb impact applied to the supporter 100. With such a configuration, a shock absorption functionality of the display apparatus may be further improved.

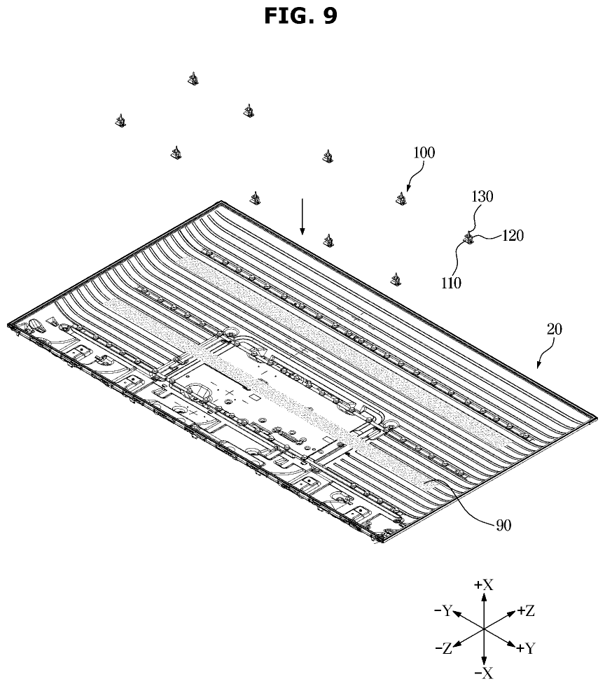

FIG. 9 is a view illustrating a manner in which the supporter is attached to a rear chassis, according to an embodiment.

Referring to FIG. 9, the supporter 100 may be attached to the front surface of the rear chassis 20. Stated differently, the supporter 100 may be bonded to the front surface of the rear chassis 20. To facilitate attachment of the supporter 100, no openings or uneven portions may be formed on the plate portion 110.

In other words, the supporter 100 may be bonded to the front surface of the rear chassis 20 by an adhesive 90. For example, the adhesive 90 may include at least one of a 2-components adhesive, a pressure sensitive adhesive (PSA), an ultraviolet (UV) adhesive, or a double-sided tape. However, the types of the adhesive 90 are not limited thereto.

In the following, the manner in which the supporter 100 is attached to the rear chassis 20 will be discussed.

The adhesive 90 may be applied to the front surface of the rear chassis 20. The adhesive 90 may be applied along one direction on the front surface of the rear chassis 20. For example, the adhesive 90 may be applied along the left-to-right direction (Y-axis direction).

A plurality of portions where the adhesive 90 is applied may be provided. For example, the adhesive 90 may be applied onto an upper portion and a lower portion, respectively.

The supporter 100 may be disposed on a portion where the adhesive 90 is applied. By disposing the supporter 100 on the portion where the adhesive 90 is applied, the supporter 100 may be bonded to the front surface of the rear chassis 20. In other words, the supporter 100 may be attached to the front surface of the rear chassis 20.

The supporter 100 may be provided in a plurality. The plurality of supporters 100 may be arranged spaced apart from each other along a direction in which the adhesive 90 extends on the portion where the adhesive 90 is applied.

As described above, a process of attaching the supporter 100 to the front surface of the rear chassis 20 may be performed only by a process of applying the adhesive 90 to the front surface of the rear chassis 20 and a process of disposing the supporter 100 on the portion where the adhesive 90 is applied. In other words, the process of attaching the supporter 100 to the front surface of the rear chassis 20 may be relatively simplified. Thus, it may be easy to automate the process of attaching the supporter 100 to the front surface of the rear chassis 20. Stated differently, it may be easier to automate the manufacturing process of the display apparatus 1.

Furthermore, the supporter 100 may be provided in a relatively small size. Thus, the process of attaching the supporter 100 to the front surface of the rear chassis 20 may be further simplified, and the manufacturing cost of the display apparatus 1 may also be reduced.

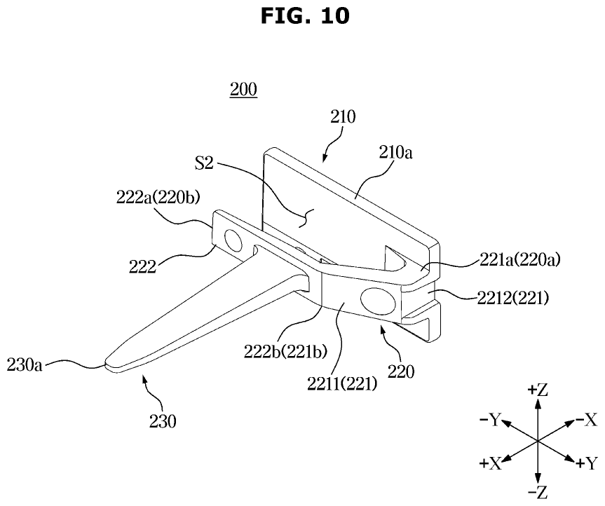

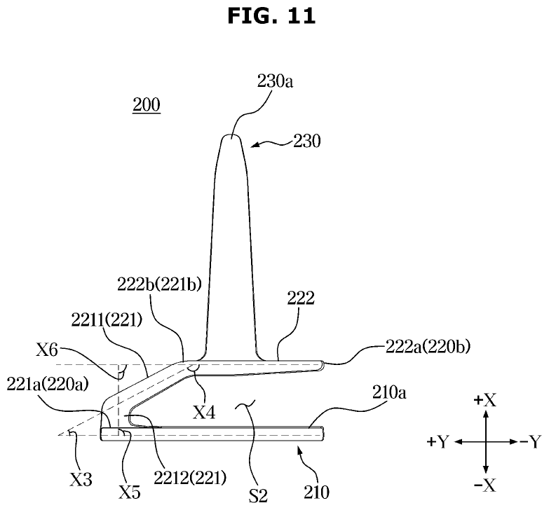

FIG. 10 is a perspective view illustrating a supporter according to an embodiment. FIG. 11 is a side view illustrating the supporter according to an embodiment.

With reference to FIGS. 10 and 11, a supporter 200 according to an embodiment of the present disclosure will be described below. In describing the supporter 200, the same reference numerals may be given to configurations that are substantially the same as the configurations shown in FIGS. 1 to 9, and further description thereof may be omitted.

Referring to FIGS. 10 and 11, the supporter 200 may include a plate portion 210. The plate portion 210 may include a front surface and a rear surface that are provided to be flat.

The plate portion 210 may include a rib for reinforcing rigidity.

The supporter 200 may include a base portion 220. The base portion 220 may protrude from the plate portion 210. Stated differently, the base portion 220 may extend from the plate portion 210. A direction in which the base portion 220 protrudes/extends from the plate portion 210 may be approximately a forward direction.

For example, the base portion 220 may protrude from one end portion of the plate portion 210. Stated differently, the base portion 220 may extend from one end portion of the plate portion 210.

One end portion 220a of the base portion 220 may be connected to the plate portion 210. The other end portion 220b of the base portion 220 may be spaced apart from the plate portion 210. For example, the other end portion 220b of the base portion 220 may be spaced apart from the plate portion 210 in a forward direction.

The base portion 220 may include an extension portion 221. The extension portion 221 may be a portion of the base portion 220 extending from the plate portion 210. Stated differently, the extension portion 221 may be a portion of the base portion 220 protruding from the plate portion 210. The extension portion 221 may extend at an incline with respect to the plate portion 210.

The one end portion 220a of the base portion 220 connected to the plate portion 210 may be one end portion 221b of the extension portion 221. In other words, one end portion 221a of the extension portion 221 may be connected to the plate portion 210.

The extension portion 221 may protrude from one end portion of the plate portion 210. Stated differently, the extension portion 221 may extend from one end portion of the plate portion 210.

The base portion 220 may include a bent portion 222. The bent portion 222 may be another portion of the base portion 220 bent from the extension portion 221. The bent portion 222 may extend in a direction different from a direction in which the extension portion 221 extends. For example, the extension portion 221 may extend at an incline in the front direction (+X direction) from the plate portion 210, and the bent portion 222 may extend in the right direction (−Y direction) from the extension portion 221.

The other end portion 220b of the base portion 220 spaced apart from the plate portion 210 may be one end portion 222a of the bent portion 222 along a direction in which the bent portion 222 extends. In other words, the one end portion 222a of the bent portion 222 along the direction in which the bent portion 222 extends may be spaced apart from the plate portion 210. For example, the one end portion 222a of the bent portion 222 along the direction in which the bent portion 222 extends may be spaced apart from the plate portion 210 in the forward direction.

The other end portion 222b of the bent portion 222 provided on an opposite side of the one end portion 222a of the bent portion 222 may be the other end portion 221b of the extension portion 221. Thus, the other end portion 222b of the bent portion 222 provided on the opposite side of the one end portion 222a of the bent portion 222 may be connected to the plate portion 210 by the extension portion 221.

The bent portion 222 may be provided parallel to the plate portion 210. For example, the plate portion 210 may be provided on the plane (YZ plane) extending in the left-to-right direction (Y-axis direction) and the up-and-down direction (Z-axis direction), and the bent portion 222 may extend in the right direction (−Y direction) from the extension portion 221. However, the direction in which the bent portion 222 extends is not limited thereto.

The extension portion 221 and the bent portion 222 may form a gap S2 together with a portion 210a of the plate portion 210. In other words, the base portion 220 may form the gap S2 together with the portion 210a of the plate portion 210.

As described above, the extension portion 221 may extend at an incline with respect to the plate portion 210. An angle at which the extension portion 221 is inclined with respect to the portion 210 a of the plate portion 210 may be 90 degrees or less. According to an embodiment, the angle at which the extension portion 221 is inclined with respect to the portion 210 a of the plate portion 210 may be less than 90 degrees. For example, the angle between the extension portion 221 and the portion 210a of the plate portion 210 may be an acute angle.

The extension portion 221 may extend at an incline with respect to the bent portion 222. An angle at which the extension portion 221 is inclined with respect to the bent portion 222 may be 90 degrees or more and 180 degrees or less. According to an embodiment, the angle at which the extension portion 221 is inclined with respect to the bent portion 222 may be greater than 90 degrees and less than 180 degrees. For example, the angle between the extension portion 221 and the bent portion 222 may be an obtuse angle.

The bent portion 222 may overlap at least a portion of the plate portion 210 based on the front-to-back direction. The bent portion 222 may overlap with the portion 210a of the plate portion 210 based on the front-to-back direction.

The supporter 200 may include a protrusion 230. The protrusion 230 may protrude forwardly from the base portion 220.

The protrusion 230 may be provided on the bent portion 222. In other words, the protrusion 230 may protrude forwardly from the bent portion 222.

The protrusion 230 may have a shape such that a thickness thereof decreases in a direction in which the protrusion 230 protrudes. Stated differently, one end portion 230a of the protrusion 230 along the direction in which the protrusion 230 protrudes may have a narrower thickness than the other end portion 230b of the protrusion 230 provided opposite the one end portion 230a of the protrusion 230.

In the following, a structure of the supporter 200 according to an embodiment will be discussed in more detail.

Referring to FIGS. 10 and 11, the extension portion 221 may include a first extension portion 2211 and a second extension portion 2212. The first extension portion 2211 and the second extension portion 2212 may be connected to each other. In addition, the first extension portion 2211 may be connected to the bent portion 222, and the second extension portion 2212 may be connected to the plate portion 210. In other words, the first extension portion 2211 may connect the second extension portion 2212 and the bent portion 222, and the second extension portion 2212 may connect the first extension portion 2211 and the plate portion 210.

The first extension portion 2211 may extend at an incline with respect to the plate portion 210. An angle X3 at which the first extension portion 2211 is inclined with respect to the portion 210 a of the plate portion 210 may be 90 degrees or less. According to an embodiment, the angle X3 at which the first extension portion 2211 is inclined with respect to the portion 210 a of the plate portion 210 may be less than 90 degrees. For example, the angle X3 between the first extension portion 2211 and the portion 210a of the plate portion 210 may be an acute angle.

The first extension portion 2211 may extend at an incline with respect to the bent portion 222. An angle X4 at which the first extension portion 2211 is inclined with respect to the bent portion 222 may be 90 degrees or more and 180 degrees or less. According to an embodiment, the angle X4 at which the first extension portion 2211 is inclined with respect to the bent portion 222 may be greater than 90 degrees and less than 180 degrees. For example, the angle X4 between the first extension portion 2211 and the bent portion 222 may be an obtuse angle.

The second extension portion 2212 may extend at an incline with respect to the plate portion 210. An angle X5 at which the second extension portion 2212 is inclined with respect to the portion 210 a of the plate portion 210 may be 90 degrees or less. According to an embodiment, the angle X5 at which the second extension portion 2212 is inclined with respect to the portion 210 a of the plate portion 210 may be less than 90 degrees. According to an embodiment, the angle X5 between the second extension portion 2212 and the portion 210 a of the plate portion 210 may be 90 degrees.

The second extension portion 2212 may extend at an incline with respect to the bent portion 222. An angle X6 at which the second extension portion 2212 is inclined with respect to the bent portion 222 may be 90 degrees or more and 180 degrees or less. According to an embodiment, the angle X6 at which the second extension portion 2212 is inclined with respect to the bent portion 222 may be greater than 90 degrees and less than 180 degrees. According to an embodiment, the angle X6 between the second extension portion 2212 and the bent portion 222 may be 90 degrees.

The protrusion 230 may be provided spaced apart from the one end portion 222a of the bent portion 222 along the direction in which the bent portion 222 extends. The protrusion 230 may be provided closer to the other end portion 222b of the bent portion 222 than to the one end portion 222a of the bent portion 222 along the direction in which the bent portion 222 extends.

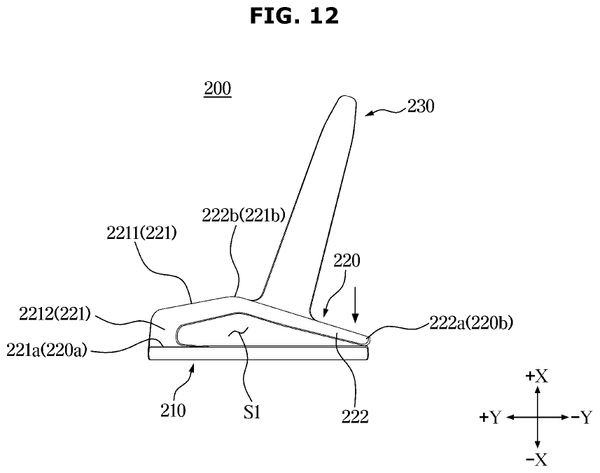

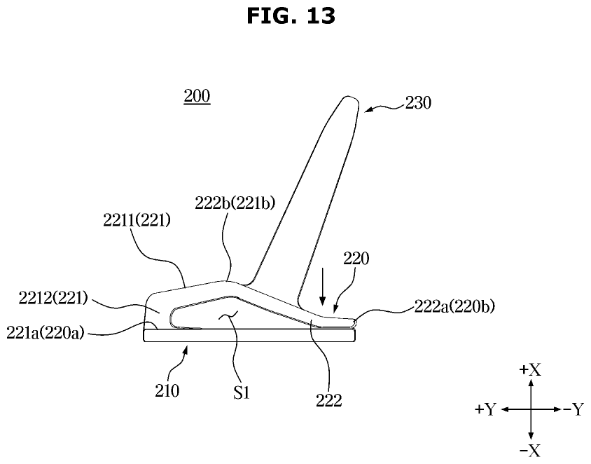

FIG. 12 is a view illustrating a state in which a supporter is primarily deformed, according to an embodiment. FIG. 13 is a view illustrating a state in which a supporter is secondarily deformed, according to an embodiment.

Referring to FIGS. 11 to 13, in a situation where an external force is applied to the display apparatus 1, the supporter 200 may be compressed. For example, the supporter 200 may be compressed in the front-to-back direction (X-axis direction). In doing so, the supporter 200 may undergo elastic deformation and absorb impact applied to the supporter 200.

The supporter 200 may have a dual damping structure to absorb impact applied to the supporter 200. That is, the supporter 200 may absorb impact by elastically deforming along two bending points.

In the following, a process by which the supporter 200 elastically deforms when the supporter 200 is compressed in the front-to-back direction (X-axis direction) will be discussed.

First, the supporter 200 may be bent with a connection portion between the extension portion 221 and the bent portion 222 as one bending point. Stated differently, the supporter 200 may be bent with the other end portion 221b of the extension portion 221, or the other end portion 222b of the bent portion 222, as one bending point. This is due to the structure of the base portion 220, wherein the one end portion 222a of the bent portion 222 is spaced apart from the plate portion 210, and the other end portion 222b of the bent portion 222 is connected to the plate portion 210 by the extension portion 221. Through the elastic deformation process described above, the supporter 200 may firstly absorb impact.

As the supporter 200 is bent along the bending point described above, the one end portion 222a of the bent portion 222 may be moved rearwardly. Stated differently, as the supporter 200 is bent along the aforementioned bending point, the one end portion 222a of the bent portion 222 may move inwardly into the gap S2. Accordingly, the one end portion 222a of the bent portion 222 may be in contact with the plate portion 210.

Thereafter, the supporter 200 may be bent with a portion of the bent portion 222 as the other bending point. A portion around the one end portion 222a of the bent portion 222 may be slightly depressed. Stated differently, the portion around the one end portion 222a of the bent portion 222 may be moved inwardly into the gap S2. Accordingly, the portion around the one end portion 222a of the bent portion 222 may be in contact with the plate portion 210. Through the aforementioned elastic deformation process, the supporter 200 may secondarily absorb impact.

In other words, the supporter 200 may undergo elastic deformation with the bent portion 222 as the other bending point. Through the aforementioned elastic deformation process, the supporter 200 may secondarily absorb impact.

As described above, the supporter 200 may have a dual damping structure to absorb impact applied to the supporter 200. With such a configuration, a shock absorption functionality of the display apparatus may be further improved.

The above describes the supporter 200 having the bent portion 222 that overlaps at least a portion of the plate portion 210 based on the front-to-back direction. For example, an entire portion of the bent portion 222 may overlap with the portion 210a of the plate portion 210 based on the front-to-back direction.

However, in some embodiments, only one portion of the bent portion may overlap with the portion 210a of the plate portion 210 based on the front-to-back direction. In this case, the other portion of the bent portion may overlap with the front surface of the rear chassis 20 based on the front-to-back direction. For example, a bent portion of a supporter according to an embodiment may extend longer in the left-to-right direction (Y-axis direction) than the bent portion 222 of the supporter 200 shown in FIGS. 10 to 13, and one end portion of the bent portion described above may overlap with the front surface of the rear chassis 20 based on the front-to-back direction, rather than the portion 210a of the plate portion 210,.

Even when the supporter is compressed in the direction (X-axis direction), the supporter may absorb impact by elastically deforming along two bending points.

First, the supporter may be bent with a connection portion between an extension portion and a bent portion as one bending point. At this time, one end portion of the bent portion may be moved rearwardly to contact the front surface of the rear chassis 20. Through the aforementioned elastic deformation process, the supporter may primarily absorb impact.

Subsequently, the supporter may be bent with a portion of the bent portion as the other bending point. A portion around one end portion of the bent portion may be slightly depressed. Accordingly, the portion around the one end portion of the bent portion may abut the plate portion or the front surface of the rear chassis 20. Through the aforementioned elastic deformation process, the supporter may secondarily absorb impact.

The display apparatus 1 according to an embodiment may include the display panel 10, the optical member 50 on a rear side of the display panel 10, the rear chassis 20 configured to support the display panel 10 and the optical member 50, and the supporter 100 or 200 between the optical member 50 and the rear chassis 20. The supporter 100 or 200 may include the plate portion 110 or 210 on a front surface of the rear chassis 20, the base portion 120 or 220 comprising a first end 120a or 220a and a second end 120b or 220b spaced, the first end 120a or 220a being connected to the plate portion 110 or 210 and the second end 120b or 220b being spaced apart from the plate portion 110 or 210, and the protrusion 130 or 230 protruding forwardly from the base portion 120 or 220.

The base portion 120 or 220 may include the extension portion 121 or 221 extending than the plate portion 110 or 210, and the bent portion 122 or 222 bent from the extension portion 121 or 221 and extending in a direction different from a direction in which the extension portion 121 or 221 extends. The first end 120a or 220a of the base portion 120 or 220 may be at an end 121a or 221a of the extension portion 121 or 221 connected to the plate portion 110 or 210. The second end 120b or 220b of the base portion 120 or 220 may be at an end 122a or 222a of the bent portion 122 or 222 along the direction in which the bent portion 122 or 222 extends.

The extension portion 121 or 221 may extend from an end portion of the plate portion 110 or 210.

The protrusion 130 or 230 may be on the bent portion 122 or 222.

The bent portion 122 or 222 may be parallel to the plate portion 110 or 210.

The extension portion 121 or 221, the bent portion 122 or 222, and the portion 110a of the plate portion 110 or 210 may form the gap S1 or S2 therebetween.

The extension portion 121 or 221 may extend at an incline with respect to the plate portion 110 or 210. The angle X1 at which the extension portion 121 or 221 is inclined with respect to the portion 110 a of the plate portion 110 or 210 may be 90 degrees or less.

The extension portion 121 or 221 may extend at an incline with respect to the bent portion 122 or 222. The angle X2 at which the extension portion 121 or 221 is inclined with respect to the bent portion 122 or 222 may be 90 degrees or more and 180 degrees or less.

The bent portion 122 or 222 may overlap at least a portion of the plate portion 110 or 210 with respect to a front-to-back direction.

The display apparatus 1 may further include the adhesive 90 configured to bond the supporter 100 or 200 to the front surface of the rear chassis 20.

The extension portion 121 may include the first extension portion 1211 and the second extension portion 1212 that are spaced apart from each other. The bent portion 122 may include the first bent portion 1221 bent from the first extension portion 1211, the second bent portion 1222 bent from the second extension portion 1212, and the connection portion 1223 connecting the first bent portion 1221 and the second bent portion 1222 and configured to support the protrusion 130.

The protrusion 130 may be inside the first bent portion 1221, the second bent portion 1222, and the connection portion 1223.

The protrusion 130 may be spaced apart from the first bent portion 1221 and the second bent portion 1222.

The extension portion 221 may include the first extension portion 2211 extending at an incline with respect to the bent portion 222, and the second extension portion 2212 connecting the first extension portion 2211 and the plate portion 210. A first angle X4 at which the first extension portion 2211 is inclined with respect to the bent portion 222 and a second angle X6 at which the second extension portion 2212 is inclined with respect to the bent portion 222 may be each 90 degrees or more and 180 degrees or less.

The protrusion 230 may be spaced apart from one end portion 222a of the bent portion 222 according to a direction in which the bent portion 222 extends.

The display apparatus 1 according to an embodiment may include the display panel 10, the optical member 50 disposed on a rear side of the display panel 10, the rear chassis 20 configured to support the display panel 10 and the optical member 50, and the supporter 100 or 200 disposed between the optical member 50 and the rear chassis 20. The supporter 100 or 200 may include the plate portion 110 or 210 provided on a front surface of the rear chassis 20, the extension portion 121 or 221 extending from the plate portion 110 or 210, the bent portion 122 or 222 bent from the extension portion 121 or 221 and extending in a direction different from a direction in which the extension portion 121 or 221 extends, and the protrusion 130 or 230 protruding from the bent portion 122 or 222 toward the optical member 50. One end portion 122a or 222a of the bent portion 122 or 222 along a direction in which the bent portion 122 or 222 extends may be spaced apart from the plate portion 110 or 210. The other end portion 122b, 222b of the bent portion 122 or 222 provided on an opposite side of the one end portion 122a or 222a of the bent portion 122 or 222 may be connected to the plate portion 110 or 210 by the extension portion 121 or 221.

The extension portion 121 or 221 and the bent portion 122 or 222 may form the gap S1 or S2 together with a portion of the plate portion 110 or 210.

The extension portion 121 or 221 may extend at an incline with respect to the plate portion 110 or 210. The angle X1 at which the extension portion 121 or 221 is inclined with respect to a portion of the plate portion 110 or 210 may be 90 degrees or less.

The extension portion 121 or 221 may extend at an incline with respect to the bent portion 122 or 222. The angle X2 at which the extension portion 121 or 221 is inclined with respect to the bent portion 122 or 222 may be 90 degrees or more and 180 degrees or less.

The bent portion 122 or 222 may overlap at least a portion of the plate portion 110 or 210 based on a front-to-back direction.

According to the spirit of the present disclosure, the display apparatus may include the supporter. The supporter may be configured to support the optical member. Furthermore, the supporter may absorb impact caused by an external force to prevent damage to the display apparatus.

According to the spirit of the present disclosure, the supporter may have the dual damping structure. Thus, even when pressure is applied to the supporter due to impact from an outside on the display apparatus, the supporter may absorb the impact by elastically deforming along two bending points. With such a configuration, a shock absorption functionality of the display apparatus may be further improved.

According to the spirit of the present disclosure, the supporter may be attached to the front surface of the rear chassis by an adhesive. Thus, it may be easier to automate a manufacturing process of the display apparatus.

The effects to be obtained from the present disclosure are not limited to the effects mentioned above, and other unmentioned effects can be clearly understood by those of ordinary skill in the art to which the present disclosure pertains from the description below.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A display apparatus, comprising:
a display panel;
an optical member on a rear side of the display panel;
a rear chassis configured to support the display panel and the optical member; and
a supporter between the optical member and the rear chassis,
wherein the supporter comprises:
a plate portion on a front surface of the rear chassis;
a base portion comprising a first end and a second end, the first end being connected to the plate portion and the second end being spaced apart from the plate portion; and
a protrusion protruding forwardly from the base portion.

2. The display apparatus of claim 1, wherein the base portion comprises:
an extension portion extending from the plate portion; and
a bent portion bent from the extension portion and extending in a direction different than a direction in which the extension portion extends, and
wherein the first end of the base portion is at an end of the extension portion that is connected to the plate portion, and the second end of the base portion is at an end of the bent portion along the direction in which the bent portion extends.

3. The display apparatus of claim 2, wherein the extension portion extends from an end portion of the plate portion.

4. The display apparatus of claim 2, wherein the protrusion is on the bent portion.

5. The display apparatus of claim 2, wherein the bent portion is parallel to the plate portion.

6. The display apparatus of claim 2, wherein the extension portion, the bent portion, and a portion of the plate portion form a gap therebetween.

7. The display apparatus of claim 6, wherein the extension portion extends at an incline with respect to the plate portion, and
wherein an angle at which the extension portion is inclined with respect to the portion of the plate portion is 90 degrees or less.

8. The display apparatus of claim 2, wherein the extension portion extends at an incline with respect to the bent portion, and
wherein an angle at which the extension portion is inclined with respect to the bent portion is 90 degrees or more and 180 degrees or less.

9. The display apparatus of claim 2, wherein the bent portion overlaps at least a portion of the plate portion with respect to a front-to-back direction.

10. The display apparatus of claim 1, further comprising an adhesive configured to bond the supporter to the front surface of the rear chassis.

11. The display apparatus of claim 2, wherein the extension portion comprises a first extension portion and a second extension portion that are spaced apart from each other, and
wherein the bent portion comprises:
a first bent portion bent from the first extension portion;
a second bent portion bent from the second extension portion; and
a connection portion connecting the first bent portion and the second bent portion and configured to support the protrusion.

12. The display apparatus of claim 11, wherein the protrusion is on an inner side of the first bent portion, the second bent portion, and the connection portion.

13. The display apparatus of claim 12, wherein the protrusion is spaced apart from the first bent portion and the second bent portion.

14. The display apparatus of claim 2, wherein the extension portion comprises:
a first extension portion extending at an incline with respect to the bent portion; and
a second extension portion connecting the first extension portion and the plate portion, and
wherein a first angle at which the first extension portion is inclined with respect to the bent portion and a second angle at which the second extension portion is inclined with respect to the bent portion are each 90 degrees or more and 180 degrees or less.

15. The display apparatus of claim 4, wherein the protrusion is spaced apart from one end portion of the bent portion along the direction in which the bent portion extends.

16. A supporter for a display apparatus that includes a display panel, an optical member on a rear side of the display panel, and a rear chassis configured to support the display panel and the optical member, the supporter comprising:
a plate portion on a front surface of the rear chassis;
a base portion comprising a first end and a second end, the first end being connected to the plate portion and the second end being spaced apart from the plate portion; and
a protrusion protruding forwardly from the base portion.

17. The supporter of claim 16, wherein the base portion comprises:
an extension portion extending from the plate portion; and
a bent portion bent from the extension portion and extending in a direction different than a direction in which the extension portion extends, and
wherein the first end of the base portion is at an end of the extension portion that is connected to the plate portion, and the second end of the base portion is at an end of the bent portion along the direction in which the bent portion extends.

18. The supporter of claim 17, wherein the extension portion extends from an end portion of the plate portion,
wherein the protrusion is on the bent portion,
wherein the bent portion is parallel to the plate portion, and
wherein the extension portion, the bent portion, and a portion of the plate portion form a gap therebetween.

19. The supporter of claim 18, wherein the extension portion extends at an incline with respect to the plate portion,
wherein an angle at which the extension portion is inclined with respect to the portion of the plate portion is 90 degrees or less, and
wherein the bent portion at least partially overlaps with the plate portion in a front-to-back direction.

20. The supporter of claim 19, wherein the extension portion further comprises a first extension portion and a second extension portion that are spaced apart from each other,
wherein the bent portion further comprises:
a first bent portion bent from the first extension portion;
a second bent portion bent from the second extension portion; and
a connection portion connecting the first bent portion and the second bent portion and configured to support the protrusion,
wherein the protrusion is on an inner side of the first bent portion, the second bent portion, and the connection portion, and
wherein the protrusion is spaced apart from the first bent portion and the second bent portion.
